(19) United States
(12) Patent Application Publication
(10) Pub. No.: US 2026/0332016 A1
(43) Pub. Date: Oct. 22, 2026

(54) LINEAR ELECTRIC MOTOR AND OIL RECOVERY APPARATUS

(71) Applicants: Jianjun ZHAO, Daqing (CN); QINGDAO CONRINGWON AUTOMATION TECHNOLOGY CO., LTD, Qingdao (CN)

(72) Inventors: Jianjun ZHAO, Daqing (CN); Runxian SUI, Qingdao (CN)

(21) Appl. No.: 19/718,095

(22) Filed: Jun. 24, 2026

Related U.S. Application Data
(63) Continuation of application No. PCT/CN2025/124406, filed on Sep. 26, 2025.

(30) Foreign Application Priority Data
Oct. 23, 2024 (CN) 202411485424.1

(51) Int. Cl. H02K 41/03; E21B 43/12; H02K 1/16; H02K 5/10

(52) U.S. Cl. CPC H02K 41/031; E21B 43/128; H02K 1/16; H02K 5/10

(57) ABSTRACT

A linear electric motor and an oil recovery apparatus are disclosed. The motor includes a stator module and a mover module. The stator module includes stator assemblies, each having an outer sleeve, an inner liner tube, and a coil winding sealed between the sleeves. The mover module is slidably disposed within the stator module and defines an oil path gap with the inner liner tube. The mover module includes mover assemblies connected by mover connecting sleeves. Each mover assembly includes a mover mandrel and an outer permanent magnet, with an internal oil channel formed within the mover mandrel. Adjacent oil channels communicate via the mover connecting sleeves. Oil flows between the oil channels and the oil path gap based on pressure differences to cool the motor, reduce upward movement resistance, and provide downward damping force.

### TECHNICAL FIELD

The present invention relates to the technical field of machinery, and particularly relates to a linear motor and an oil recovery apparatus.

### BACKGROUND

As oil extraction technology improves and extraction becomes more difficult, increasingly higher requirements are imposed on oil extraction equipment. Currently, downhole submersible linear motor processes and oil recovery pump processes are often used to improve the efficiency of downhole oil extraction and extend the service life of oil extraction devices.

In an oil extraction method using a linear motor, an oil recovery pump is placed in an oil well and driven by the linear motor to perform the oil pumping operation. For example, a Chinese Patent CN112283063A discloses an integrated machine and pump oil extraction device and method, wherein a linear motor stator portion is assembled on a pump barrel and a mover serves as a plunger. Under the action of an excitation magnetic field of the motor stator, the pump plunger reciprocates to achieve oil pumping. However, the pump barrel requires a certain strength and has a thick wall, resulting in a large motor air gap and affecting motor efficiency. Additionally, the pump plunger is integrated into the motor mover and located inside the motor stator, and it needs to cooperate with multiple ball valves built into the stator to pump oil, thereby resulting in a complex overall structure and low oil recovery efficiency. Furthermore, another Chinese Patent CN108880178A discloses a multi-stage linear motor and an oil recovery pump thereof, both of which are independent. However, during use, the linear motor needs to apply thrust to the oil recovery pump. Due to limitations in the structural strength of the linear motor, the stroke thereof is relatively short, resulting in low oil pumping efficiency. Therefore, designing technology to improve oil extraction efficiency is a technical problem to be solved by the present invention.

The technical problem that the present invention aims to solve is to provide a linear motor and an oil recovery apparatus that can be used reliably and improve the efficiency of oil pumping.

### SUMMARY

The technical solution provided by the present invention is a linear motor, comprising a stator module.

The stator module comprises a plurality of stator assemblies, each of which comprises an outer sleeve, an inner liner tube, and a coil winding. The coil winding and the inner liner tube are arranged inside the outer sleeve. The coil winding is sleeved on the inner liner tube and is sealingly arranged between the outer sleeve and the inner liner tube. Two adjacent outer sleeves are sealingly connected together.

The mover module comprises a plurality of mover assemblies and a mover connection sleeve. Each mover assembly comprises a mover mandrel and a permanent magnet. The permanent magnet is arranged on an exterior of the mover mandrel. An oil channel is formed inside the mover mandrel. A side wall of the mover connection sleeve is provided with a through opening. Two adjacent mover mandrels are connected together through the mover connection sleeve, and two adjacent oil channels communicate through the mover connection sleeve.

The mover module is arranged in the stator module, the mover mandrel is slidable in the inner liner tube, and an oil path gap is formed between the mover module and the inner liner tube.

In an embodiment of the present invention, the oil path gap communicates with the oil channel.

In an embodiment of the present invention, the oil channel is configured to allow oil to flow upward within the oil channel during a downward stroke of the mover mandrel; and the oil path gap is configured to allow oil to flow upward within the oil path gap during the downward stroke of the mover mandrel.

In an embodiment of the present invention, the oil channel is configured such that oil flows downward within the oil channel during an upward stroke of the mover mandrel; and the oil path gap is configured such that oil flows downward within the oil path gap during the upward stroke of the mover mandrel.

In an embodiment of the present invention, the stator assembly further comprises two end seals, wherein each end seal is provided with a first installation through-hole; the end seals are sealingly inserted into corresponding pipe openings of the outer sleeve, and ends of the inner liner tube are sealingly inserted into the first installation through-holes; the coil winding is located between the two end seals, and the mover mandrel passes through the first installation through-holes.

In an embodiment of the present invention, the stator module further comprises a stator connector, wherein the stator connector is provided with a second installation through-hole; two adjacent stator assemblies are sealingly and fixedly connected together through the stator connector, the stator connector is sealingly connected to the end seal at a corresponding end in the stator assembly, and the mover mandrel passes through the second installation through-hole.

In an embodiment of the present invention, the end seal is provided with first wiring holes, and the stator connector is provided with second wiring holes; for the end seal and the stator connector that are connected together, the first wiring hole communicates with the second wiring hole; a cable connected to the coil winding passes through the first wiring hole and the second wiring hole; the stator module further comprises a motor head and an external wiring terminal, the motor head is further provided with a third installation through-hole, the motor head is further provided with a wiring channel, and the external wiring terminal is sealingly arranged in the wiring channel; the motor head is connected to the stator assembly at the top, and the third installation through-hole is configured for the mover mandrel to pass through; and the cable connected to the coil winding further extends into the wiring channel and connects to the external wiring terminal.

In an embodiment of the present invention, an inner end face of the end seal is further provided with first keyways, a stator core of the coil winding is provided with second keyways, the first keyway communicates with the second keyway, and the cable connected to the coil winding is further arranged in the first keyway and the second keyway.

In an embodiment of the present invention, the stator module further comprises: a pressure balance assembly, wherein the pressure balance assembly comprises an outer protective tube and an oil pressure sensing component, and the oil pressure sensing component is arranged in the outer protective tube; a first pressure balance cavity is formed within the oil pressure sensing component, and the first pressure balance cavity is configured to be filled with electrical insulating oil; the oil pressure sensing component is configured to deform under the action of hydraulic pressure within the outer protective tube to adjust pressure within the first pressure balance cavity; a second pressure balance cavity is formed between the outer sleeve and the inner liner tube, and the second pressure balance cavity is configured to be filled with electrical insulating oil; wherein the first pressure balance cavity and the second pressure balance cavity communicate.

In an embodiment of the present invention, the pressure balance assembly is arranged between two adjacent stator assemblies, and the mover mandrel of at least one mover assembly is inserted into the outer sleeve; or, the pressure balance assembly is arranged on the stator assembly located at the bottom in the stator module, and the mover mandrel of at least one mover assembly is inserted into the outer sleeve.

In an embodiment of the present invention, each first pressure balance cavity respectively communicates with each second pressure balance cavity; or, two adjacent second pressure balance cavities communicate with each other, and the first pressure balance cavity communicates with the second pressure balance cavity in the mover assembly at the bottom.

In an embodiment of the present invention, the stator assembly further comprises two end seals, wherein each end seal is provided with a first installation through-hole; the end seals are sealingly inserted into corresponding pipe openings of the outer sleeve, and ends of the inner liner tube are sealingly inserted into the first installation through-holes; the outer sleeve and the inner liner tube form a second pressure balance cavity between the two end seals, the coil winding is located between the two end seals, and the mover mandrel passes through the first installation through-holes.

In an embodiment of the present invention, the end seal is further provided with first pressure communication holes, wherein the first pressure communication hole communicates with the second pressure balance cavity; and in two stator assemblies connected together, the first pressure communication hole in one stator assembly communicates with an adjacent first pressure communication hole in another stator assembly.

In an embodiment of the present invention, the stator module further comprises a stator connector, wherein the stator connector is provided with a second installation through-hole, and the stator connector is further provided with second pressure communication holes; two adjacent stator assemblies are sealingly and fixedly connected together through the stator connector, the stator connector is sealingly connected to the end seal at a corresponding end in the stator assembly, and the mover mandrel passes through the second installation through-hole; and for the end seal and the stator connector that are connected together, the first pressure communication hole communicates with the second pressure communication hole.

In an embodiment of the present invention, the stator module further comprises a motor head and an external wiring terminal, wherein the motor head is further provided with a third installation through-hole, a wiring channel, and an oil injection hole, the oil injection hole and the wiring channel are arranged on an exterior of the third installation through-hole, and the external wiring terminal is sealingly arranged in the wiring channel; the motor head is connected to the stator assembly at the top, and the third installation through-hole is configured for the mover mandrel to pass through; a cable connected to the coil winding further extends into the wiring channel and connects to the external wiring terminal; and the oil injection hole communicates with an adjacent second pressure balance cavity.

In an embodiment of the present invention, the linear motor further comprises an upper oil buffer pipe and/or a lower oil buffer pipe; the upper oil buffer pipe is arranged at the top of the stator module, and the lower oil buffer pipe is arranged at the bottom of the stator module; the upper oil buffer pipe is configured to communicate with the mover mandrel located at the top, and the lower oil buffer pipe is configured to communicate with the mover mandrel located at the bottom; and/or,
the mover module further comprises a lower buffer connection assembly, wherein the lower buffer connection assembly comprises two lower mounting bases and a lower spring, the lower spring is connected between the two lower mounting bases, the lower mounting base located on an upper side is connected to the mover mandrel located at the bottom, and the lower mounting base located on a lower side is configured to connect to the oil recovery pump.

The present invention further provides an oil recovery apparatus, comprising an oil recovery pump, and further comprising the aforementioned linear motor, wherein the oil recovery pump is arranged below the linear motor, the linear motor is vertically arranged, and the mover mandrel of the mover assembly located at the bottom in the linear motor is connected to the oil recovery pump.

The present invention further provides an oil recovery apparatus, comprising an oil recovery pump, and further comprising the aforementioned linear motor, wherein the linear motor is horizontally arranged, the oil recovery pump is arranged at a rear end of the linear motor, and the mover mandrel of the mover assembly located at a rear end in the linear motor is connected to the oil recovery pump.

Compared with the prior art, the advantages and positive effects of the present invention are as follows: when the mover module is assembled into the inner liner tube, an oil path gap is formed between the mover module and the inner liner tube, and an oil channel is formed inside the mover mandrel of the mover module, wherein the oil path gap and the oil channel communicate with each other. During use, the oil recovery pump is connected to the bottom of the mover module, and the mover mandrel exerts a tensile force on the oil recovery pump to lift oil upwards. This reduces the structural strength requirements imposed on the mover mandrel and extends the reciprocating movement stroke to meet the requirements of oil recovery pumps with different strokes. Thus, this further expands the application, improves the working state of the oil recovery pump, enables long-term stable operation, enhances oil pumping volume and oil pumping efficiency, and extends the pump inspection cycle.

In addition, the oil channel formed in the mover mandrel, together with the oil path gap between the mover module and the inner liner tube, allows oil, which has been pumped by the oil recovery pump, to flow upwards. Meanwhile, oil can flow between the oil channel and the oil path gap due to the differential oil pressure. During the reciprocating operation process of the mover assembly, therefore, oil can flow between the oil channel and the oil path gap. On one hand, the flowing oil plays a role in absorbing heat and reducing temperature, thereby improving the running reliability of the linear motor. On the other hand, the flowing oil reduces the resistance and pressure generated during the up-stroke of the mover assembly and provides a damping force during the down-stroke of the mover assembly, thereby improving operational stability and smooth operation.

Additionally, the linear motor is capable of withstanding high pressure due to its structural design, mechanical strength, and sealing performance, which satisfies the requirements of a high-pressure working environment in an oil well. The oil recovery pump is installed in the lower or rear portion of the linear motor, and it can work either in an oil-submerged state or in a state separated from well fluid. When lifting well fluid to the ground, the motor mover and the oil recovery pump plunger undergo tensile stress, resulting in an effective force application mode and a stable system. The statement that the linear motor can operate in a state isolated from well fluid refers to the installation of the linear motor inside the oil well, above the pump submergence depth and the fluid level. This ensures that the cable is completely isolated from prolonged immersion in well fluid, thereby extending cable service life.

In addition, the present invention can be used in coordination with tubing-transported pumps or rod pumps, which are currently widely used in oilfields.

### DESCRIPTION OF DRAWINGS

FIG. 1 is a schematic structural view of an embodiment of a linear motor of the present invention;

FIG. 2 is a cross-sectional view of the embodiment of the linear motor of the present invention;

FIG. 3 is a partial enlarged schematic view of region A in FIG. 2;

FIG. 4 is a partial enlarged schematic view of region B in FIG. 2;

FIG. 5 is an assembly view of a stator assembly, a stator connector, and a motor head in FIG. 1;

FIG. 6 is a cross-sectional view of the stator assembly in FIG. 1;

FIG. 7 is a partial schematic structural view of the stator assembly and the stator connector in FIG. 1;

FIG. 8 is a schematic structural view of an end seal in FIG. 7;

FIG. 9 is a schematic structural view of the stator connector in FIG. 1;

FIG. 10 is a schematic assembly view of a mover assembly and a mover connection sleeve;

FIG. 11 is a cross-sectional assembly view of the mover assembly and the mover connection sleeve in FIG. 10;

FIG. 12 is a schematic structural view of the mover connection sleeve in FIG. 10;

FIG. 13 is a schematic structural view of a pressure balance assembly in FIG. 1;

FIG. 14 is a cross-sectional view of the pressure balance assembly in FIG. 1.

### DETAILED DESCRIPTION

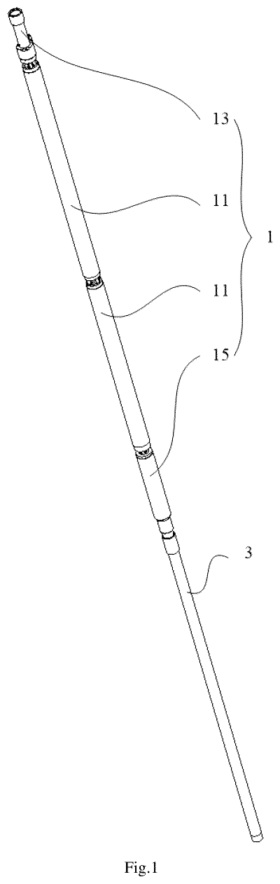

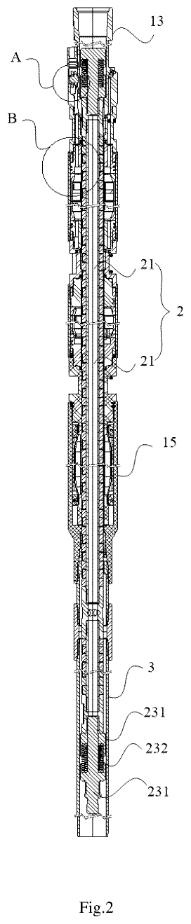

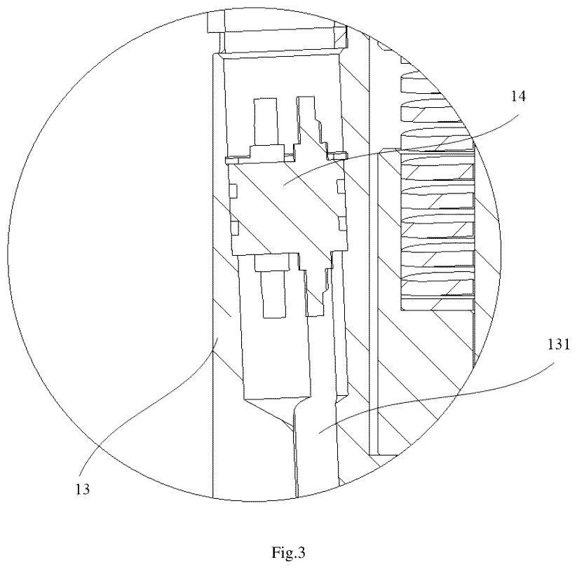

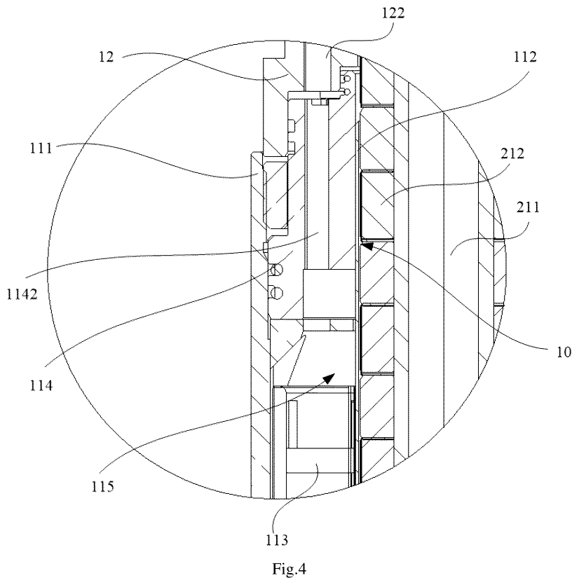

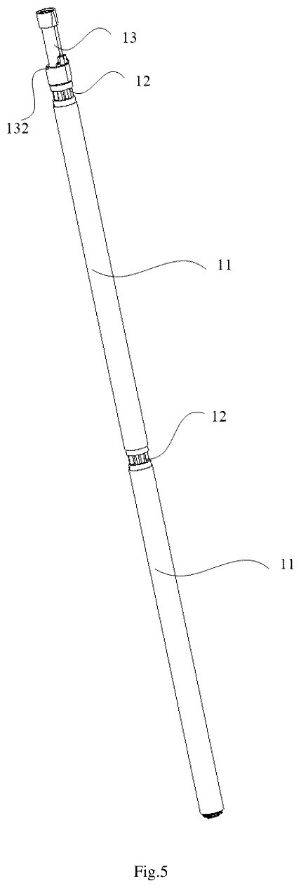

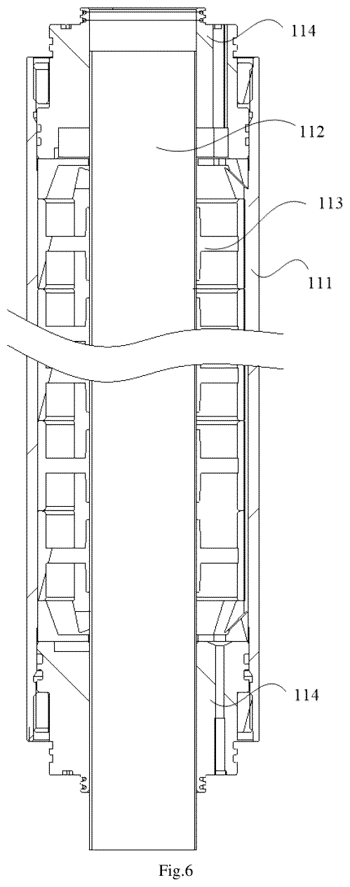

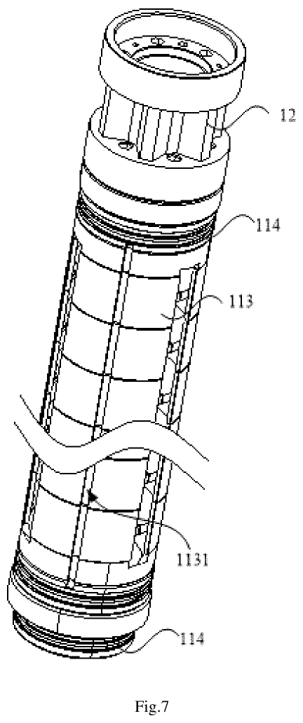

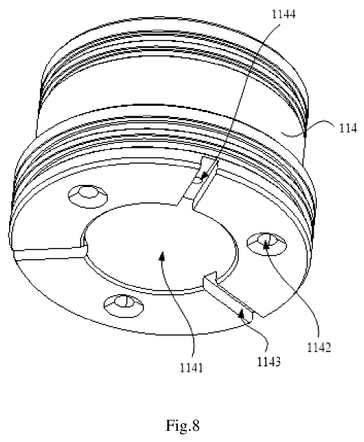

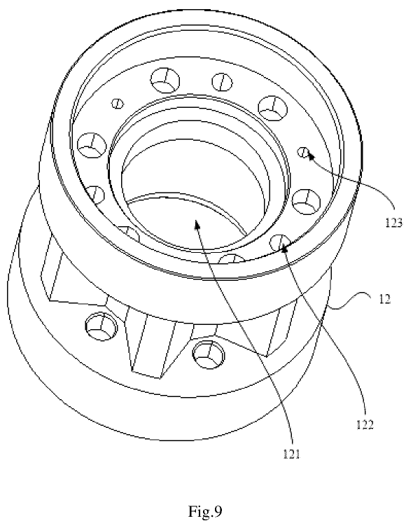

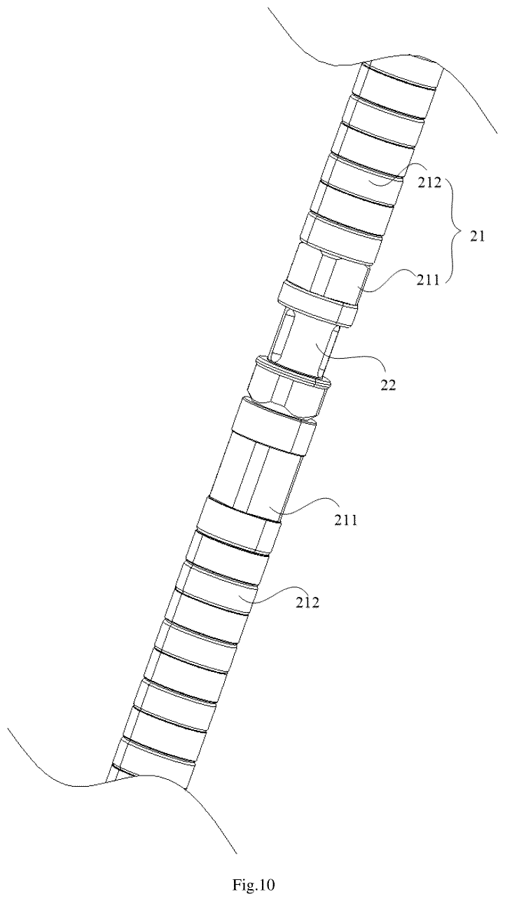

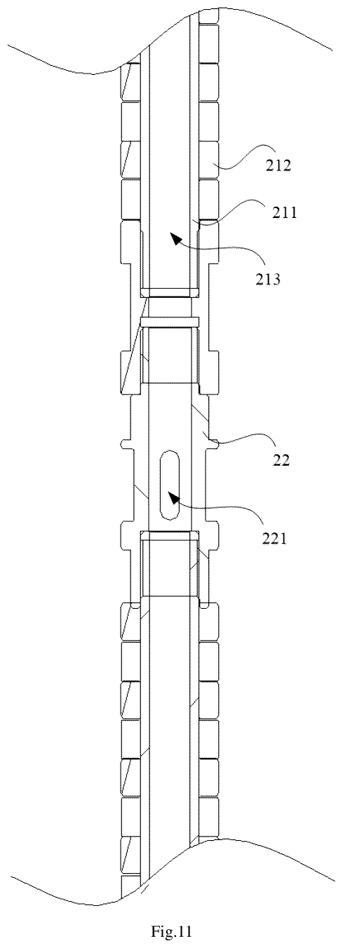

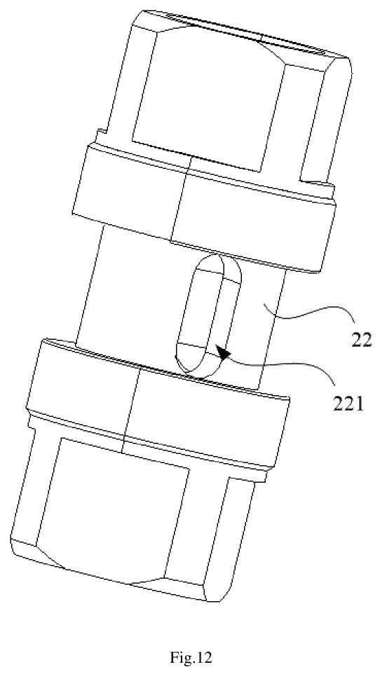

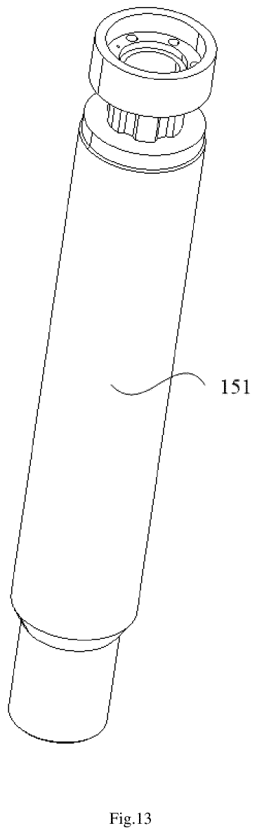

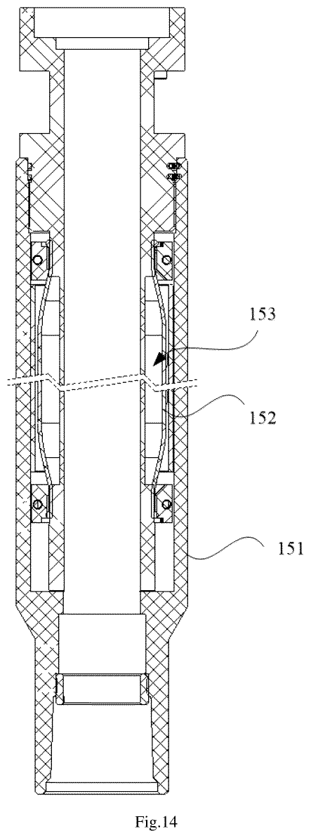

As shown in FIGS. 1 to 14, one embodiment of the present invention provides a linear motor.

The linear motor comprises: a stator module 1, which comprises a plurality of stator assemblies 11. Each stator assembly 11 comprises an outer sleeve 111, an inner liner tube 112, and a coil winding 113. The coil winding 113 and the inner liner tube 112 are arranged within the outer sleeve 111. The coil winding 113 is sleeved onto the inner liner tube 112 and is sealingly arranged between the outer sleeve 111 and the inner liner tube 112. Two adjacent outer sleeves 111 are sealingly connected together.

The linear motor comprises a mover module 2, the mover module 2 comprises a plurality of mover assemblies 21 and a mover connection sleeve 22. Each mover assembly 21 comprises a mover mandrel 211 and a permanent magnet 212. The permanent magnet 212 is arranged on the exterior of the mover mandrel 211 and an oil channel 213 is formed inside the mover mandrel 211. A side wall of the mover connection sleeve 22 is provided with a through opening 221. Two adjacent mover mandrels 211 are connected together through the mover connection sleeve 22, and two adjacent oil channels 213 communicate through the mover connection sleeve 22.

The mover module 2 is arranged in the stator module 1 and the mover mandrel 211 is slidable in the inner liner tube 112. An oil path gap 10 is formed between the mover module 2 and the inner liner tube 112.

In the linear motor provided by the present invention, the mover module 2 is assembled in the stator module 1. The coil winding 113 in the stator module 1 is energized to cooperate with the permanent magnet 212 in the mover module 2, driving the mover mandrel 211 to reciprocate within the stator module 1.

The outer sleeve 111 of the stator module 1 serves as an external support and protective component, and the thickness of the outer sleeve 111 needs to satisfy pressure resistance and structural strength requirements. The inner liner tube 112 and the coil winding 113 are installed inside the outer sleeve 111. The coil winding 113 is located within a sealed space between the outer sleeve 111 and the inner liner tube 112 to insulate and isolate it from oil. The inner liner tube is made of a non-magnetic material to ensure sufficient magnetic force is generated between the coil winding 113 and the permanent magnet 212.

In the mover module 2, the mover mandrel 211 serves as a support and installation component. The permanent magnet 212 is sleeved and fixed to the exterior of the mover mandrel 211. The interior of the mover mandrel 211 has a hollow structure that forms the oil channel 213. In this manner, during a process in which the mover mandrel 211 drives an oil recovery pump at the bottom to work, the oil pumped by the oil recovery pump can be transported upward through the mover mandrel 211, thereby achieving the transportation of oil above ground level.

While driving the oil recovery pump to work, the mover mandrel 211 provides a tensile force to the oil recovery pump, enabling it to pump oil into the oil channel 213. The mover mandrel 211 can provide a large tensile force, thus meeting the requirements for high-power oil recovery pumps.

Oil flowing in the oil channel 213 within the mover mandrel 211 can further flow into the oil path gap 10 via the through opening 221. During use, oil can flow between the oil path gap 10 and the oil channel 213.

During use, the oil in the oil path gap 10 can also take away heat generated by the coil winding 113 at the corresponding position through heat exchange with the inner liner tube 112. This improves the reliability of the linear motor during use.

The flow cross-sectional area of the oil channel 213 is much larger than that of the oil path gap 10. Oil flowing between the oil path gap 10 and the oil channel 213 improves the smooth running of the mover assembly 21 and reduces internal pressure.

During a downward stroke of the mover mandrel 211, the mover assembly 21 drives the oil recovery pump plunger, which is used in coordination with the present invention, downwards. The oil recovery pump plunger squeezes oil entering the pump barrel below it up into the pump barrel above the plunger, preparing for oil pumping in a next stroke cycle. At this time, oil in the lower oil buffer pipe 3 rises within the oil channel 213 relative to the mover mandrel 211, and oil also rises within the oil path gap 10 relative to the inner liner tube 112. The flow of oil conforms to thermodynamic principles. As it flows through the linear motor, the upward-flowing oil fully absorbs the heat generated by the operation of the linear motor, and carries it to an oil pipe at the front of the motor head 13. Oil is continuously pushed towards the wellhead during the oil pumping process of the next stroke cycle.

In addition, during an upward stroke of the mover mandrel 211, the mover assembly 21 drives the oil recovery pump plunger upwards and lifts oil from the pump barrel, located at the top of the oil recovery pump plunger, into the lower oil buffer pipe 3. Meanwhile, the front portion of the mover assembly 21, as it moves upwards and enters the tubing space at the front portion of the motor head 13, pushes oil within the tubing space towards the wellhead. As the diameter of the mover assembly 21 is slightly larger than that of the oil recovery pump plunger, a small amount of oil flows downwards within the oil channel 213 relative to the mover mandrel 211, and another small amount of oil flows downwards within the oil path gap 10 relative to the inner liner tube 112, entering the lower oil buffer pipe 3. The volume of oil flowing downward in this portion offsets the volume difference between the mover assembly 21 and the oil recovery pump plunger in the same stroke. Therefore, during the upward stroke, the force exerted on the mover assembly 21 only includes the resistance to the upward movement of the oil recovery pump plunger.

As described above, the mover assembly 21 of the linear motor drives the oil recovery pump plunger at the bottom in a regular reciprocating cycle of upward movement and downward movement, pumping oil continuously from a deep portion of an oil layer out of a ground wellhead within an oil well, thereby achieving a complete and efficient oil extraction process. Since the pumped oil fully absorbs heat of the linear motor, the temperature of oil is relatively high compared with conventional extraction methods, preventing wax formation and freezing blockage inside the oil pipe.

In one embodiment of the present invention, the stator assembly 11 further comprises two end seals 114, each of which is provided with a first installation through-hole 1141. The end seals 114 are sealingly inserted into the corresponding pipe openings in the outer sleeve 111 and the ends of the inner liner tube 112 are sealingly inserted into the first installation through-holes 1141. The coil winding 113 is located between the two end seals 114, and the mover mandrel 211 passes through the first installation through-holes 1141.

To facilitate the sealed installation of the coil winding 113 in the stator assembly 11, the end seals 114 are correspondingly arranged at the two ends of the stator assembly 11. The end seals 114 are capable of sealingly connecting the outer sleeve 111 and the inner liner tube 112 at corresponding ends together, enabling the coil winding 113 to be sealingly assembled between the outer sleeve 111 and the inner liner tube 112.

A sealing mode can be adopted between the end seal 114 and both the outer sleeve 111 and the inner liner tube 112, such as welding or adding a sealing ring, which is not limited herein.

Furthermore, the stator module 1 further comprises a stator connector 12 provided with a second installation through-hole 121. Two adjacent stator assemblies 11 are sealingly and fixedly connected together through the stator connector 12. The stator connector 12 is sealingly connected to the end seal 114 at a corresponding end of the stator assembly 11, and the mover mandrel 211 passes through the second installation through-hole 121.

Specifically, to achieve a convenient and fast connection between the two adjacent stator assemblies 11, the two adjacent stator assemblies 11 are connected and fixed through the stator connector 12. The stator connector 12 can then be connected to the end seal 114 at the corresponding end of the stator assembly 11 using bolts or a similar method.

Furthermore, to facilitate the power supply to each coil winding 113 via a cable, the end seal 114 is fitted with first wiring holes 1142, and the stator connector 12 is provided with second wiring holes 122. When connected, the first wiring hole 1142 and the second wiring hole 122 communicate with each other and a cable connected to the coil winding 113 passes through them. The stator module 1 also comprises a motor head 13 and an external wiring terminal 14. The motor head 13 is further fitted with a third installation through-hole. The motor head 13 is further provided with a wiring channel 131, and the external wiring terminal 14 is sealingly arranged in the wiring channel 131. The motor head 13 is connected to the stator assembly 11 at the top, and the third installation through-hole is configured to allow the mover mandrel 211 to pass through. The cable connected to the coil winding 113 further extends into the wiring channel 131 and connects to the external wiring terminal 14.

Specifically, to supply power to the coil winding 113 in the stator module 1, an external power source is connected to the coil windings 113 in different stator assemblies 11 through cables. Since the stator module 1 has a relatively long overall length, the motor head 13 is arranged at the topmost of the stator assembly 11 to facilitate cable arrangement. The external wiring terminal 14 is arranged on the motor head 13 to facilitate connection with the external power source. Inside the stator module 1, the cables extend into the wiring channel 131 and connect to the external wiring terminal 14. Between two adjacent stator assemblies 11, cables can therefore be routed via the first wiring hole 1142 and the second wiring hole 122. The motor head 13 at the top can then draw electricity through the external wiring terminal 14 and be electrically connected to the cables in the wiring channel 131.

To facilitate the positioning of the coil winding 113 in the stator assembly 11 for wiring inside the stator assembly 11, the inner end face of the end seal 114 is further provided with first keyways 1143 and the stator core of the coil winding 113 is provided with second keyways 1131. The first keyway 1143 and the second keyway 1131 communicate with each other and a positioning key (not shown) is arranged in the second keyway 1131. An end of the positioning key is then inserted into the first keyway 1143.

Specifically, inside the stator assembly 11, cables lead out through the first wiring hole 1142 of the end seal 114. These cables need to be connected precisely to the coil windings 113, which are stacked and arranged sequentially. To this end, the coil windings 113 need to be accurately positioned. The second keyway 1131 on the stator core of the coil winding 113 accurately positions the plurality of coil windings 113 through the positioning key. The end of the positioning key is then inserted into the first keyway 1143 of the end seal 114, maintaining the high precision of the relative position between the end seal 114 and the coil winding 113, thereby facilitating the accurate routing of cables during assembly.

Another embodiment of the present invention comprises the stator module 1 with a pressure balance assembly 15. The pressure balance assembly 15 comprises an outer protective tube 151 and an oil pressure sensing component 152. The oil pressure sensing component 152 is arranged within the outer protective tube 151. A first pressure balance cavity 153 is formed within the oil pressure sensing component 152. The first pressure balance cavity 153 is configured to be filled with electrical insulating oil. The oil pressure sensing component 152 deforms under the action of hydraulic pressure within the outer protective tube 151 to adjust the pressure within the first pressure balance cavity 153. A second pressure balance cavity 115 is formed between the outer sleeve 111 and the inner liner tube 112. The second pressure balance cavity 115 is configured to be filled with electrical insulating oil; and the first pressure balance cavity 153 and the second pressure balance cavity 115 communicate.

Specifically, to reduce the overall outer peripheral size of the linear motor, the inner liner tube 112 inside is made as thin as possible, except where the outer sleeve 111 needs to be made of relatively thick material to satisfy structural strength requirements.

However, due to the working conditions of oil extraction on site, the linear motor needs to be submerged in a relatively deep formation. Under the influence of bottom oil pressure, the inner liner tube 112 needs to withstand the pressure of the oil within the oil path gap 10. The relatively thin inner liner tube 112 may be damaged due to its low structural strength. However, once the pressure balance assembly 15 has been added, the first pressure balance cavity 153 formed by the pressure balance assembly 15 communicates with an adjacent second pressure balance cavity 115. In turn, the two adjacent second pressure balance cavities 115 communicate with each other. Under the action of the internal electrical insulating oil, the pressure in the first pressure balance cavity 153 can be substantially the same as the pressure in the second pressure balance cavities 115.

During use, the oil pressure sensing component 152 deforms under the pressure of oil within the outer protective tube 151. This ensures that the pressure of the electrical insulating oil within the first pressure balance cavity 153 is substantially the same as the pressure of the oil within the outer protective tube 151. Thus, the pressure of the electrical insulating oil in the second pressure balance cavities 115 can be close to the pressure in the oil path gap 10, so the structural strength of the relatively thin inner liner tube 112 can satisfy the use requirements for a differential pressure between the two sides. This improves the safety and reliability of the linear motor and satisfies the design requirement for miniaturization of the outer peripheral size of the linear motor.

The oil pressure sensing component 152 can be a pressure capsule containing electrical insulating oil. The pressure capsule abuts against the inner wall of the outer protective tube 151 and is located on the exterior of the mover assembly 21. Alternatively, the oil pressure sensing component 152 comprises a support tube and an elastic tube. The two ends of the support tube and the two ends of the elastic tube are sealingly connected together to form the first pressure balance cavity 153. The oil pressure sensing component 152 is sleeved on the exterior of the mover assembly 21, and the elastic tube deforms under the action of external oil pressure. This restricts the difference between the pressure within the second pressure balance cavity 115 and the external oil pressure to a small range. The specific structural forms of the oil pressure sensing component 152 are not limited or repeated herein.

In one embodiment, the pressure balance assembly 15 is positioned between two adjacent stator assemblies 11, and the mover mandrel 211 of at least one mover assembly 21 is inserted into the outer sleeve 111. In this configuration, the two adjacent second pressure balance cavities 115 communicate with each other, and each first pressure balance cavity 153 communicates with one of the second pressure balance cavities 115.

As an alternative arrangement, the pressure balance assembly 15 is positioned on the stator assembly 11, which is located at the bottom of the stator module 1. The mover mandrel 211 of at least one mover assembly 21 is then inserted into the outer sleeve 111. In this configuration, the two adjacent second pressure balance cavities 115 communicate with each other, and the first pressure balance cavity 153 communicates with the second pressure balance cavity 115 in the mover assembly 21 at the bottom.

To facilitate wiring and cable installation, the following description uses an example where the pressure balance assembly 15 is arranged on the stator assembly 11 at the topmost bottom.

During use, once the linear motor has been placed in an oil well, the pressure balance assembly 15 is positioned next to an oil recovery pump at the bottom. Oil pumped by the oil recovery pump first flows into the pressure balance assembly 15 and then sequentially flows through each stator assembly 11. The oil pressure sensing component 152 adjusts the internal pressure of the electrical insulating oil according to the external oil pressure, ensuring the reliable operation of the linear motor.

Furthermore, the stator assembly 11 comprises two end seals 114, each of which is provided with a first installation through-hole 1141. The end seals 114 are sealingly inserted into the corresponding pipe openings of the outer sleeve 111 and the ends of the inner liner tube 112 are sealingly inserted into the first installation through-holes 1141. The outer sleeve 111 and the inner liner tube 112 form a second pressure balance cavity 115 between the two end seals 114. The coil winding 113 is located between the two end seals 114, and the mover mandrel 211 passes through the first installation through-holes 1141.

Specifically, the second pressure balance cavity 115 is formed once the outer sleeve 111 and the inner liner tube 112 in the stator assembly 11 are sealingly connected through the end seals 114. To enable communication between the second pressure balance cavities 115, the end seal 114 is provided with first pressure communication holes 1144, which communicate with the second pressure balance cavity 115.

The electrical insulating oil in the second pressure balance cavity 115 can enter and exit through the first pressure communication hole 1144. This allows the electrical insulating oil can be utilized to balance pressure within the second pressure balance cavities 115 at different positions.

In two connected stator assemblies 11, the first pressure communication hole 1144 in one stator assembly 11 communicates with an adjacent first pressure communication hole 1144 in the other stator assembly 11. Additionally, the stator assembly 11 adjacent to the pressure balance assembly 15 communicates with the first pressure balance cavity 153 of the pressure balance assembly 15 via the first pressure communication hole 1144.

The first keyway 1143, which is arranged on the end seal 114, extends to the first installation through-hole 1141 via an end face of the end seal 114. One end of the first keyway 1143 extends to and communicates with the first installation through-hole 1141 and the other end of the first keyway 1143 extends to an outer side wall of the end seal 114. Meanwhile, the first pressure communication hole 1144 is located within the first keyway 1143.

After assembly, the electrical insulating oil in the first pressure balance cavity can enter and exit the first pressure communication hole 1144 via the first keyway 1143, which is arranged transversely. This ensures a smooth flow of internal electrical insulating oil between the different pressure balance cavities.

Furthermore, the stator module 1 comprises a stator connector 12 with a second installation through-hole 121 and second pressure communication holes 123. Two adjacent stator assemblies 11 are fixedly and sealingly connected together through the stator connector 12, which is also sealingly connected to the end seal 114 at the corresponding end of the stator assembly 11. The mover mandrel 211 passes through the second installation through-hole 121. The first pressure communication hole 1144 of the end seal 114 communicates with the second pressure communication hole 123 of the stator connector 12.

Specifically, two adjacent stator assemblies 11 are connected and fixed together through the stator connector 12. A specific description of how the stator connector 12 connects two stator assemblies 11 is not repeated herein.

The stator connector 12 is fitted with the second pressure communication hole 123. For two adjacent stator assemblies 11, the stator connector 12 is connected together with corresponding end seals 114, and the first pressure communication holes 1144 of the two end seals 114 are connected through the second pressure communication hole 123 of the stator connector 12.

Furthermore, the stator module 1 comprises a motor head 13 and an external wiring terminal 14. The motor head 13 has a third installation through-hole, an oil injection hole 132, and a wiring channel 131, the oil injection hole 132 and the wiring channel 131 are on the exterior of the third installation through-hole. The external wiring terminal 14 is sealingly arranged in the wiring channel 131. The motor head 13 is connected to the stator assembly 11 at the top, and the third installation through-hole is configured for the mover mandrel 211 to pass through. A cable connected to the coil winding 113 extends into the wiring channel 131 and connects to the external wiring terminal 14. The oil injection hole 132 communicates with an adjacent second pressure balance cavity 115.

Specifically, the motor head 13 is fixedly installed on the stator assembly 11 at the topmost and the stator assembly 11 achieves a sealed and fixed connection with the motor head 13 through the stator connector 12. For the specific configuration in which the motor head 13 and the external wiring terminal 14 establish a cable connection to the coil winding 113, reference is made to the preceding description, as details will not be repeated here.

The oil injection hole 132 is located on the motor head 13. During assembly, electrical insulating oil can be injected into the second pressure balance cavity 115 through the oil injection hole 132, filling both the second pressure balance cavity 115 and the first pressure balance cavity 153.

Another embodiment of the present invention comprises a linear motor with an upper oil buffer pipe and/or a lower oil buffer pipe 3.

The upper oil buffer pipe is arranged at the top of the stator module 1 and the lower oil buffer pipe is arranged at the bottom of the stator module 1. The upper oil buffer pipe communicates with the mover mandrel 211 located at the top, and the lower oil buffer pipe 3 is configured to communicate with the mover mandrel 211 located at the bottom.

Specifically, the lower oil buffer pipe 3 provides continuous protection when the plurality of mover assemblies 21 at the bottom move out of the bottommost stator assembly 11. During an upward stroke of the mover assemblies 21, oil pumped by an oil recovery pump enters into the lower oil buffer pipe to ensure smooth and efficient oil pumping delivery.

Similarly to the upper oil buffer pipe, during use, after the plurality of mover assemblies 21 at the top move out of the stator assembly 11 at the topmost, the upper oil buffer pipe provides continuous protection through. During the up-and-down stroke movements of the mover assembly 21, oil is also buffered through the upper oil buffer pipe.

Another embodiment of the present invention improves the connection reliability between the mover assembly 21 and the oil recovery pump at the bottom by incorporating a lower buffer connection assembly 23 into the mover module 2.

The lower buffer connection assembly 23 comprises two lower installation seats 231 and a lower spring 232. The lower spring 232 is connected between the two lower installation seats 231, with the lower installation seat 231 located above connected to the mover mandrel 211 located at the bottom and the lower installation seat 231 located below configured to connect to the oil recovery pump.

Specifically, the mover mandrel 211 of the mover assembly 21, which is located at the bottom, needs to be connected to the oil recovery pump. Connection and fixation are achieved between the mover mandrel 211 and the oil recovery pump through the lower buffer connection assembly 23. During use, the lower spring 232 undergoes elastic deformation in response to force, thereby buffering the impact force generated by the mover assembly 21 on the oil recovery pump during switching processes between up and down strokes, so as to improve use reliability.

Another embodiment of the present invention further provides an oil recovery apparatus comprising an oil recovery pump and a linear motor described above, wherein the linear motor is vertically arranged with the oil recovery pump below. The mover mandrel 211 of the mover assembly 21 located at the bottom of the linear motor is connected to the oil recovery pump.

Specifically, the oil recovery apparatus comprises the oil recovery pump and the linear motor in the above embodiment. The linear motor is arranged vertically under the use state and located above the oil recovery pump. This exerts a tensile force on the plunger of the oil recovery pump through the linear motor, driving the oil recovery pump to pump oil.

Since the linear motor is arranged above the oil recovery pump, it only needs to ensure the submergence depth of the oil recovery pump to meet requirements for pumping oil. The linear motor can be located partially below the liquid level or above it.

During the pumping process, the oil pressure sensing component 152 is submerged in the well fluid that is pumped out by the oil recovery pump. Through the transmission of the electrical insulating oil, the internal pressure of the linear motor can dynamically balance the pressure within the well fluid channel of the oil extraction machine in real time. As the pressure difference is relatively small or there is no pressure difference, the sealing effects at various sealing positions are safe and reliable and the linear motor is not damaged by the pressure of the well fluid. This achieves long-term smooth operation.

Another embodiment of the present invention, the present invention further provides an oil recovery apparatus comprising an oil recovery pump and the linear motor described above, which is horizontally arranged with the oil recovery pump at the rear end of the linear motor. The mover mandrel 211 of the mover assembly 21, located at the rear end of the linear motor, connects to the oil recovery pump.

Specifically, the oil recovery apparatus in the above embodiment comprises the oil recovery pump and the linear motor. The linear motor is arranged horizontally in an oil well in use. This allows the oil recovery pump to be positioned behind the linear motor, enabling the plunger of the oil recovery pump to be driven by the linear motor to pump oil.

1-12. (canceled)

13. A linear motor, comprising:
a stator module, wherein the stator module comprises a plurality of stator assemblies, each stator assembly comprises an outer sleeve, an inner liner tube, and a coil winding, the coil winding and the inner liner tube are arranged in the outer sleeve, the coil winding is sleeved on the inner liner tube and is sealingly arranged between the outer sleeve and the inner liner tube, and two adjacent outer sleeves are sealingly connected together; and
a mover module, wherein the mover module comprises a plurality of mover assemblies and a mover connection sleeve, each mover assembly comprises a mover mandrel and a permanent magnet, the permanent magnet is arranged on an exterior of the mover mandrel, and an oil channel is formed inside the mover mandrel; a side wall of the mover connection sleeve is provided with a through opening, two adjacent mover mandrels are connected together through the mover connection sleeve, and two adjacent oil channels communicate through the mover connection sleeve;
wherein the mover module is slidably arranged in the stator module, and the mover module is inserted into the inner liner tube; and
an oil path gap is formed between the mover module and the inner liner tube; oil flowing in the oil channel within the mover mandrel can flow into the oil path gap via the through opening; oil can flow between the oil path gap and the oil channel;
the stator module further comprises: a pressure balance assembly, wherein the pressure balance assembly comprises an outer protective tube and an oil pressure sensing component, and the oil pressure sensing component is arranged in the outer protective tube;
a first pressure balance cavity is formed within the oil pressure sensing component, and the first pressure balance cavity is configured to be filled with electrical insulating oil; the oil pressure sensing component deforms under the action of hydraulic pressure within the outer protective tube to adjust the pressure within the first pressure balance cavity; and
a second pressure balance cavity is formed between the outer sleeve and the inner liner tube, and the second pressure balance cavity is configured to be filled with electrical insulating oil;
wherein the first pressure balance cavity and the second pressure balance cavity communicate.

14. The linear motor according to claim 13, wherein the stator assembly further comprises two end seals, and each end seal is provided with a first installation through-hole;
the end seals are sealingly inserted into corresponding pipe openings of the outer sleeve, and ends of the inner liner tube are sealingly inserted into the first installation through-holes; and
the coil winding is located between the two end seals, and the mover mandrel passes through the first installation through-holes.

15. The linear motor according to claim 14, wherein the stator module further comprises a stator connector, and the stator connector is provided with a second installation through-hole;
two adjacent stator assemblies are sealingly and fixedly connected together through the stator connector, the stator connector is sealingly connected to the end seal at a corresponding end in the stator assembly, and the mover mandrel passes through the second installation through-hole.

16. The linear motor according to claim 15, wherein the end seal is provided with first wiring holes, and the stator connector is provided with second wiring holes;
for the end seal and the stator connector that are connected together, the first wiring hole communicates with the second wiring hole; and
a cable connected to the coil winding passes through the first wiring hole and the second wiring hole.

17. The linear motor according to claim 13, wherein the pressure balance assembly is arranged between two adjacent stator assemblies, and the mover mandrel of at least one mover assembly is inserted into the outer sleeve; or,
the pressure balance assembly is arranged on the stator assembly located at the bottom of the stator module, and the mover mandrel of at least one mover assembly is inserted into the outer sleeve.

18. The linear motor according to claim 17, wherein the first pressure balance cavity respectively communicates with the second pressure balance cavity; or,
two adjacent second pressure balance cavities communicate with each other, and the first pressure balance cavity communicates with the second pressure balance cavity in the stator assembly at the bottom.

19. The linear motor according to claim 13, wherein the stator assembly further comprises two end seals, and each end seal is provided with a first installation through-hole;
the end seals are sealingly inserted into corresponding pipe openings of the outer sleeve, and ends of the inner liner tube are sealingly inserted into the first installation through-holes; the outer sleeve and the inner liner tube form the second pressure balance cavity between the two end seals, the coil winding is located between the two end seals, and the mover mandrel passes through the first installation through-holes.

20. The linear motor according to claim 19, wherein the end seal is further provided with first pressure communication holes, and the first pressure communication hole communicates with the second pressure balance cavity; and
in two stator assemblies connected together, the first pressure communication hole in one stator assembly communicates with an adjacent first pressure communication hole in another stator assembly.

21. The linear motor according to claim 20, wherein the stator module further comprises a stator connector, the stator connector is provided with a second installation through-hole, and the stator connector is further provided with second pressure communication holes;
two adjacent stator assemblies are sealingly and fixedly connected together through the stator connector, the stator connector is sealingly connected to the end seal at a corresponding end in the stator assembly, and the mover mandrel passes through the second installation through-hole; and
for the end seal and the stator connector that are connected together, the first pressure communication hole communicates with the second pressure communication hole.

22. The linear motor according to any one of claim 13, wherein the linear motor further comprises an upper oil buffer pipe and/or a lower oil buffer pipe; the upper oil buffer pipe is arranged at the top of the stator module, and the lower oil buffer pipe is arranged at the bottom of the stator module; the upper oil buffer pipe is configured to communicate with the mover mandrel located at an upper portion, and the lower oil buffer pipe is configured to communicate with the mover mandrel located at a lower portion; and/or,
the mover module further comprises a lower buffer connection assembly, the lower buffer connection assembly comprises two lower installation seats and a lower spring, the lower spring is connected between the two lower installation seats, the lower installation seat located above is connected to the mover mandrel located at the bottom, and the lower installation seat located below is configured to be connected to an oil recovery pump.

23. An oil recovery apparatus, comprising an oil recovery pump, and further comprising the linear motor according to claim 13, wherein: the linear motor is vertically arranged, the oil recovery pump is arranged below the linear motor, and the mover mandrel of the mover assembly located at the bottom in the linear motor is connected to the oil recovery pump; or,
the linear motor is horizontally arranged, the oil recovery pump is arranged at a rear end of the linear motor, and the mover mandrel of the mover assembly located at the rear end in the linear motor is connected to the oil recovery pump.
